(19) United States
(12) Patent Application Publication
(10) Pub. No.: US 2019/0376329 A1
(43) Pub. Date: Dec. 12, 2019

(54) HINGE GUARD SYSTEM AND METHOD

(71) Applicant: Joseph L. Paquet, Campbell River (CA)

(72) Inventor: Joseph L. Paquet, Campbell River (CA)

(21) Appl. No.: 16/001,853

(22) Filed: Jun. 6, 2018

(51) Int. Cl. E05D 11/10; E05D 11/00

(52) U.S. Cl. CPC E05D 11/1014; E05Y 2900/132; E05D 11/0054

(57) ABSTRACT

A device for securement over a hinge of a door; the device for securement over a hinge of a door includes a sleeve-body including an inner-capacity defined by an outer-shell having a closed-end, a substantially open-end opposite the closed-end, a length therebetween, and a hinge-receiving aperture spanning the length of the outer-shell from the substantially open-end and terminating before the closed-end. The device for securement over a hinge of a door is useful for installation over the hinge of the door to provide added security to the door.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of security devices and more specifically relates to a device for installation over a hinge of a door to provide added security to the door.

### 2. DESCRIPTION OF RELATED ART

Door chains, swing bars, a variety of swing guards, and other types of door guards are widely used as security devices for a door. These door guards allow an occupant to open the door and leave a gap (small opening) to allow the occupant to talk and see or receive objects through the open gap. However, these door guards have their vulnerabilities and can easily be circumvented once the door has been opened either by lock picking or, in the worst case scenario, by an actual key. An intruder, a trespasser or a thief can cut or even force the door guard to spring out of the door and/or the door frame just with a strong push against the door, forcing the screws holding the door guard in place to pop out. Thus, a suitable solution is desired.

U.S. Pub. No. 2015/0008684 to Henry Kong Sun Ching relates to a portable door guard hinge security device. The described portable door guard hinge security device includes a portable door guard used to secure the door at the hinge, particularly the wings of the hinge. The portable door guard comprises a retractable, non-permanently fixed device that can be secured around the hinge of the door from the inside to prohibit the door to open more than a gap. The portable door guard includes a center area designed to grip the hinge to limit the swinging movement of the hinge and adjusting means to configure the size of the gap.

### BRIEF SUMMARY OF THE INVENTION

In view of the foregoing disadvantages inherent in the known security devices art, the present disclosure provides a novel hinge guard system and method. The general purpose of the present disclosure, which will be described subsequently in greater detail, is to provide a device for installation over a hinge of a door to prevent unwanted opening of the door.

A hinge guard device is disclosed herein. The device includes a sleeve-body which may include an inner-capacity defined by an outer-shell, the outer-shell having a closed-end, a substantially open-end opposite the closed-end, a length therebetween, and a hinge-receiving aperture spanning the length of the outer-shell from the substantially open-end and terminating before the closed-end. The device may be configured to slide over a hinge-body of the hinge when the at least two hinge-wings are in the closed-condition, and further configured to secure the hinge-body within the inner-capacity of the sleeve-body such that the door has limited ability to open.

A method of using the device is also disclosed herein. The method of using the device may comprise the steps of: providing the device as above; closing the door; sliding the substantially open-end of the sleeve-body over the hinge-body when the two hinge-wigs are in the closed-condition, until the hinge-body reaches the closed-end of the sleeve-body; and securing the hinge-body within the inner-capacity of the sleeve-body.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a hinge guard system and method, constructed and operative according to the teachings of the present disclosure.

FIG. 1 is a front perspective view of the device during an ‘in-use’ condition, according to an embodiment of the disclosure.

FIG. 2 is a front perspective view of the device of FIG. 1, according to an embodiment of the present disclosure.

FIG. 3 is a front perspective view of the device of FIG. 1, according to an embodiment of the present disclosure.

FIG. 4 is a front perspective view of the device of FIG. 1, according to an embodiment of the present disclosure.

FIG. 5 is a flow diagram illustrating a method of use for the device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to security devices and more particularly to a hinge guard system and method as used to provide a device for installation over a hinge of a door to provide added security to the door.

Generally, the present device is intended to stop unwanted opening of doors and prevent criminals or others from unwanted entry. The device may be used in combination with a safety chain and may allow the door to be opened up to 3 inches to allow a home owner to talk through the door whilst remaining safe inside. The device may be made from aluminum and include a brushed aesthetically pleasing look. However, it should be appreciated that other materials may be used. In use, the device may be slipped over an interior portion of a hinge on a door to prevent the interior portion from being able to rotate and open the door. When the home owner needs to be open the door, they may lift the device off the door hinge. The present device may further be made as a kit including three devices therein.

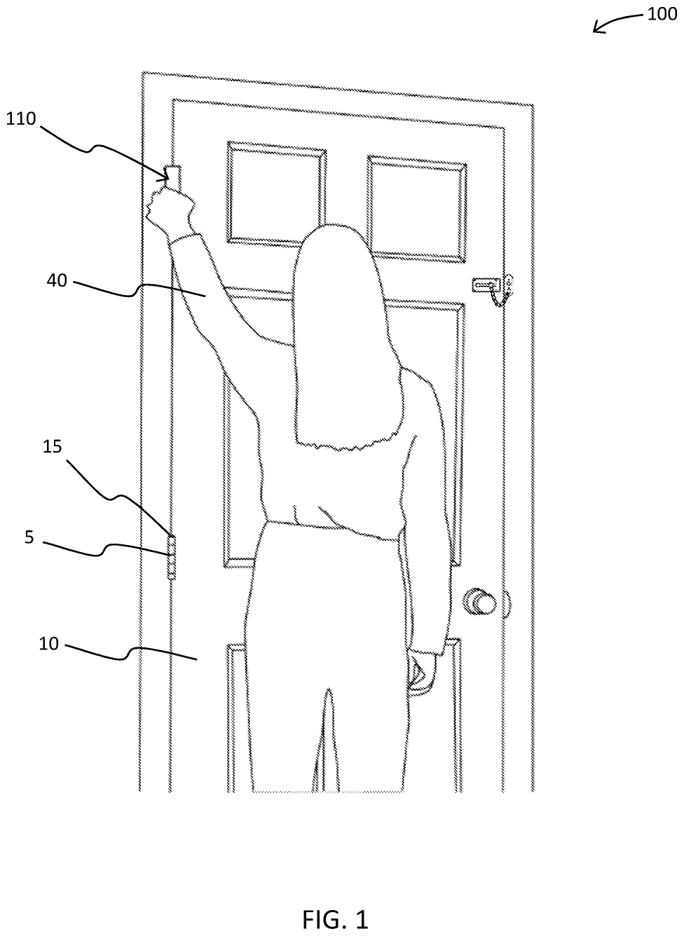

Referring now more specifically to the drawings by numerals of reference, there is shown in FIGS. 1-4, various views of a device 100.

FIG. 1 shows a device 100 during an ‘in-use’ condition 150, according to an embodiment of the present disclosure. As illustrated, the device 100 may include a sleeve-body 110. The sleeve-body 110 may be configured for securement over a hinge 5 of a door 10, the hinge including a hinge-body 15 and at least two hinge-wings 20, the at least two hinge-wings 20 being pivotable between an open-condition and a closed-condition via opening and closing of the door 10.

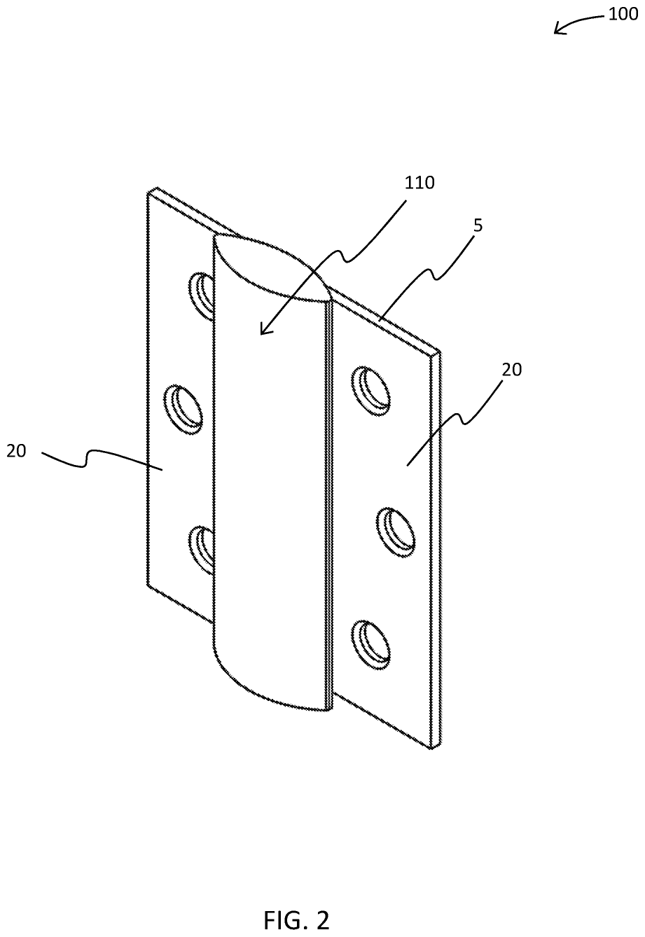

FIG. 2 shows a front perspective view of the device 100 of FIG. 1, according to an embodiment of the present disclosure. The device 100 may be configured to slide over the hinge-body 15 (FIG. 1) when the at least two hinge-wings 20 are in the closed-condition, and further configured to secure the hinge-body 15 within the inner-capacity 112 of the sleeve-body 110 such that the door 10 (FIG. 1) has limited ability to open.

In one embodiment, the sleeve-body 110 may be made from a ferrous-material or alternatively a non-ferrous material. The ferrous-material may be steel. The non-ferrous-material may comprise aluminum. In another embodiment, the sleeve-body 110 may be made from an alloy-material. Further, as shown, the sleeve-body 110 may comprise a cylindrical-shape. However, it should be appreciated that other shapes are contemplated. For example, rectangular, tubular, etc.

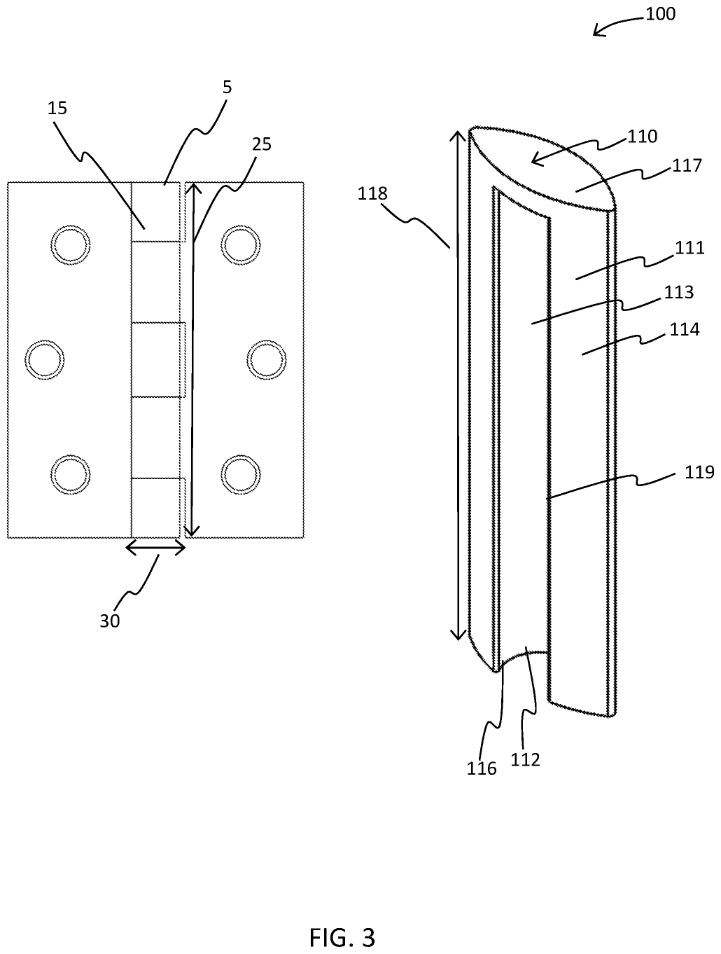

Referring now to FIG. 3 showing a front perspective view of the device 100 of FIG. 1, according to an embodiment of the present disclosure. As shown, the sleeve-body 110 may include an inner-capacity 112 defined by an outer-shell 114 having a closed-end 117, a substantially open-end 116 opposite the closed-end 117, a length 118 therebetween, and a hinge-receiving aperture 119 spanning the length 118 of the outer-shell 114 from the substantially open-end 116 and terminating before the closed-end 117. In addition to this, the length 118 of the sleeve-body 110 may be sized to accommodate a hinge-length 25 of the hinge-body 15. For example, the length 118 of the sleeve-body 110 may be equal to the hinge-length 25 of the hinge-body 15. In another embodiment, the length 118 of the sleeve-body 110 may be lesser than the hinge-length 25 of the hinge-body 15.

As shown, the hinge-receiving aperture 119 may be located on a back-side 111 of the sleeve-body 110. The back-side 111 of the sleeve-body 110 may include a securement-lip 113 around a periphery of the hinge-receiving aperture 119 configured to aid in securement of the hinge-body 15 when in the inner-capacity 112 of the sleeve-body 110.

Further, as shown, the hinge-receiving aperture 119 may terminate at the substantially open-end 116 such that the hinge-body 15 is able to slide through the hinge-receiving aperture 119 via the substantially open-end 116. The opening of the substantially open-end 116 may include a C-shaped configuration. The hinge-receiving aperture 119 may comprise a cylindrical-profile. In addition to this, the hinge-receiving aperture 119 may be sized to accommodate a hinge-width 30 of the hinge-body 15. In one example, the hinge-receiving aperture 119 may include a width greater than the hinge-width 30 of the hinge-body 15.

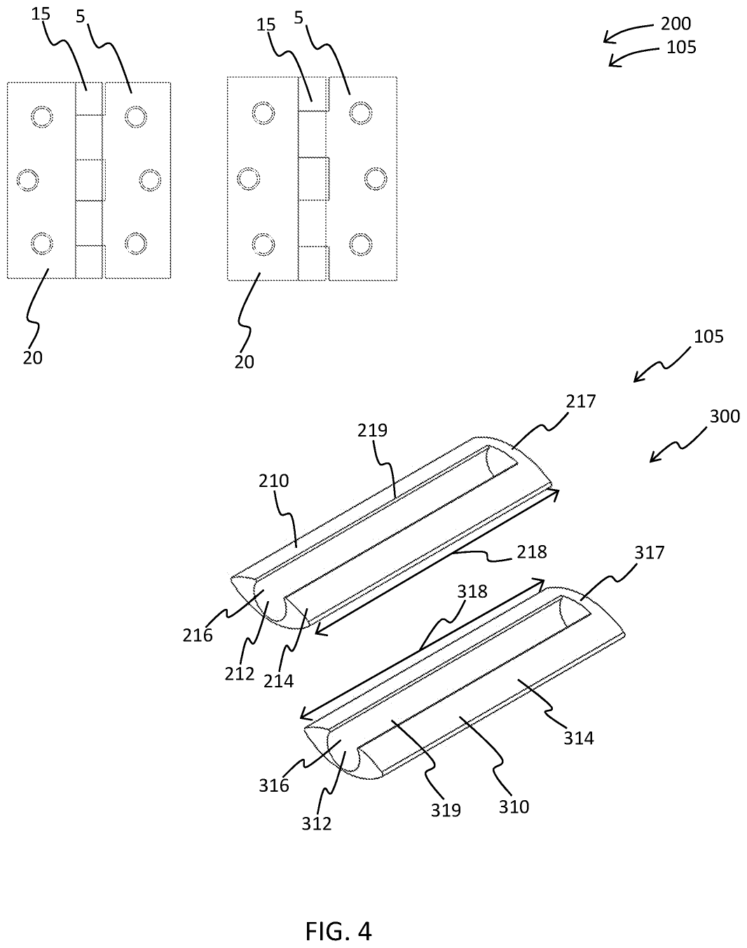

FIG. 4 shows a front perspective view of a kit 105, according to an embodiment of the present disclosure. The kit 105 may be for securing at least two hinges 5 of a door 10, the at least two hinges 5 each including the hinge-body 15 and two hinge-wings 20, the two hinge-wings 20 being pivotable between the open-condition and the closed-condition via opening and closing of the door 10.

As shown, the kit 105 may include a first-device 200 and a second-device 300 for securement over one of the at least two hinges 5 of the door 10. The first-device 200 may include a first sleeve-body 210 having a first inner-capacity 212 defined by a first outer-shell 214 including a first closed-end 217, a first substantially open-end 216 opposite the first closed-end 217, a first length 218 therebetween, and a first hinge-receiving aperture 219 spanning the first length 218 of the first outer-shell 214 from the first substantially open-end 216 and terminating before the first closed-end 217. Similarly, the second-device 300 may include a second sleeve-body 310 having a second inner-capacity 312 defined by a second outer-shell 314 including a second closed-end 317, a second substantially open-end 316 opposite the second closed-end 317, a second length 318 therebetween, and a second hinge-receiving aperture 319 spanning the second length 318 of the second outer-shell 314 from the second substantially open-end 316 and terminating before the second closed-end 317.

The first-device 200 may be configured to slide over one of the hinge-body 15 when one of the two hinge-wings 20 are in the closed-condition, and further configured to secure the one of the hinge-body 15 within the first inner-capacity 212 of the first sleeve-body 110 such that the door 10 has limited ability to open. Similarly, the second-device 300 may be configured to slide over another one of the hinge-body 15 when another one of the two hinge-wings 20 are in the closed-condition, and further configured to secure the another one of the hinge-body 15 within the second inner-capacity 312 of the second sleeve-body 110 such that the door 10 has the limited ability to open. In the preferred embodiment, the kit 105 may further include a third-device and the at least two-hinges 5 may comprise three-hinges 5.

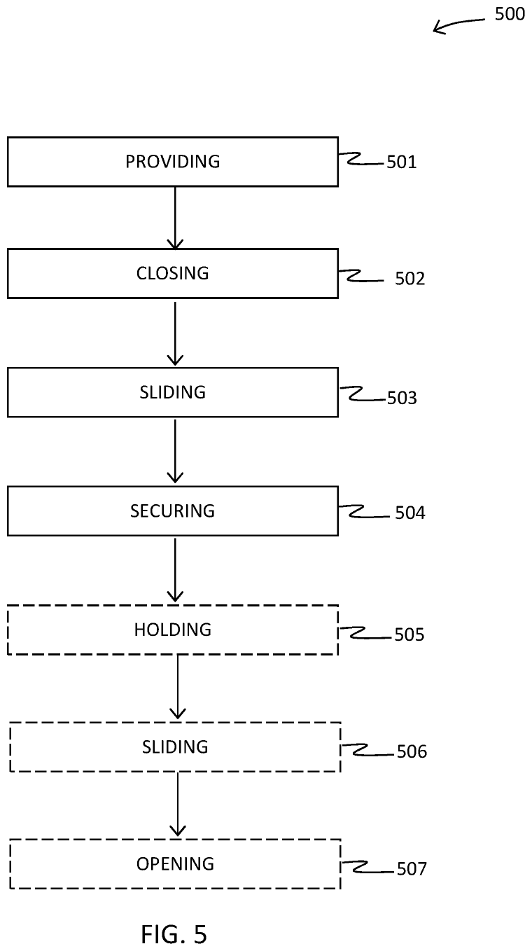

Referring now to FIG. 5, a flow diagram illustrating a method of using a device for securement over a hinge of a door 500, according to an embodiment of the present disclosure. As illustrated, the method of using a device for securement over a hinge of a door 500 may include the steps of: step one 501, providing the device 100 as above; step two 502, closing the door 10; step three 503, sliding the substantially open-end 116 of the sleeve-body 110 over the hinge-body 15 when the two hinge-wigs are in the closed-condition, until the hinge-body 15 reaches the closed-end 117 of the sleeve-body 110; and step four 504, securing the hinge-body 15 within the inner-capacity 112 of the sleeve-body 110. Further steps may include: step five 505, holding the sleeve-body 110; step six 506, sliding the sleeve-body 110 from the hinge-body 15 until the sleeve-body 110 is removed from the hinge-body 15; and step 507, opening the door 10.

It should be noted that step five 505, step six 506, and step seven 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for installation/use of device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for securement over a hinge of a door, the hinge including a hinge-body and at least two hinge-wings, the at least two hinge-wings being pivotable between an open-condition and a closed-condition via opening and closing of the door, the device comprising:
a sleeve-body including an inner-capacity defined by an outer-shell, the outer-shell having a closed-end, a substantially open-end opposite the closed-end, a length therebetween, and a hinge-receiving aperture spanning the length of the outer-shell from the substantially open-end and terminating before the closed-end; and
wherein the device is configured to slide over the hinge-body when the at least two hinge-wings are in the closed-condition, and further configured to secure the hinge-body within the inner-capacity of the sleeve-body such that the door has limited ability to open.

2. The device of claim 1, wherein the sleeve-body is made from a ferrous-material.

3. The device of claim 1, wherein the sleeve-body is made from a non-ferrous-material comprising aluminum.

4. The device of claim 1, wherein the sleeve-body is made from an alloy-material.

5. The device of claim 2, wherein the ferrous-material is steel.

6. The device of claim 1, wherein the sleeve-body comprises a cylindrical-shape.

7. The device of claim 1, wherein the hinge-receiving aperture comprises a cylindrical-profile.

8. The device of claim 1, wherein the hinge-receiving aperture terminates at the substantially open-end such that the hinge-body is able to slide through the hinge-receiving aperture via the substantially open-end.

9. The device of claim 1, wherein an opening of the substantially open-end includes a C-shaped configuration.

10. The device of claim 1, wherein the length of the sleeve-body is sized to accommodate a hinge-length of the hinge-body.

11. The device of claim 1, wherein the length of the sleeve-body is equal to the hinge-length of the hinge-body.

12. The device of claim 1, wherein the length of the sleeve-body is lesser than the hinge-length of the hinge-body.

13. The device of claim 1, wherein the hinge-receiving aperture is sized to accommodate a hinge-width of the hinge-body.

14. The device of claim 13, wherein the hinge-receiving aperture includes a width greater than the hinge-width of the hinge-body.

15. The device of claim 1, wherein the hinge-receiving aperture is located on a back-side of the sleeve-body.

16. The device of claim 1, wherein the back-side of the sleeve-body includes a securement-lip around a periphery of the hinge-receiving aperture configured to aid in securement of the hinge-body when in the inner-capacity of the sleeve-body.

17. A kit for securing at least two hinges of a door, the at least two hinges each including a hinge-body and two hinge-wings, the two hinge-wings being pivotable between an open-condition and a closed-condition via opening and closing of the door, the kit comprising:
a first-device for securement over one of the at least two hinges of the door, the first-device including:
a first sleeve-body having a first inner-capacity defined by a first outer-shell, the first outer-shell including a first closed-end, a first substantially open-end opposite the first closed-end, a first length therebetween, and a first hinge-receiving aperture spanning the first length of the first outer-shell from the first substantially open-end and terminating before the first closed-end; and
a second-device for securement over another one of the at least two hinges of the door, the second-device including:
a second sleeve-body having a second inner-capacity defined by a second outer-shell, the second outer-shell including a second closed-end, a second substantially open-end opposite the second closed-end, a second length therebetween, and a second hinge-receiving aperture spanning the second length of the second outer-shell from the second substantially open-end and terminating before the second closed-end; and
wherein the first-device is configured to slide over one of the hinge-body when one of the two hinge-wings are in the closed-condition, and further configured to secure the one of the hinge-body within the first inner-capacity of the first sleeve-body such that the door has limited ability to open; and
wherein the second-device is configured to slide over another one of the hinge-body when another one of the two hinge-wings are in the closed-condition, and further configured to secure the another one of the hinge-body within the second inner-capacity of the second sleeve-body such that the door has the limited ability to open.

18. The kit of claim 17, further comprising a third-device; and
wherein the at least two-hinges comprise three-hinges.

19. A method of using a device for securement over a hinge of a door, the method comprising the steps of:
providing a device for securement over the hinge of the door, the hinge including a hinge-body and two hinge-wings, the two hinge-wings being pivotable between an open-condition and a closed-condition via opening and closing of the door, the device including:
a sleeve-body including an inner-capacity defined by an outer-shell, the outer-shell having a closed-end, a substantially open-end opposite the closed-end, a length therebetween, and a hinge-receiving aperture spanning the length of the outer-shell from the substantially open-end and terminating before the closed-end;
closing the door;
sliding the substantially open-end of the sleeve-body over the hinge-body when the two hinge-wigs are in the closed-condition, until the hinge-body reaches the closed-end of the sleeve-body; and
securing the hinge-body within the inner-capacity of the sleeve-body.

20. The method of claim 19, further comprising the steps of:
holding the sleeve-body;
sliding the sleeve-body from the hinge-body until the sleeve-body is removed from the hinge-body; and
opening the door.
